(19) United States
(12) Patent Application Publication
(10) Pub. No.: US 2016/0041317 A1
(43) Pub. Date: Feb. 11, 2016

(54) DISPLAY DEVICE

(71) Applicant: Samsung Display Co., Ltd., Yongin-City (KR)

(72) Inventors: Youngchan KIM, Incheon (KR); Oleg PRUDNIKOV, Hwaseong-si, Gyeonggi-do (KR)

(21) Appl. No.: 14/622,698

(22) Filed: Feb. 13, 2015

(30) Foreign Application Priority Data
Aug. 8, 2014 (KR) 10-2014-0102465

(51) Int. Cl. G02B 5/20; G02B 5/02; F21V 8/00

(52) U.S. Cl. CPC G02B 5/201; G02B 6/0011; G02B 5/02

(57) ABSTRACT

The display device includes a backlight unit, a color filter and a shutter panel. The color filter is formed on the backlight unit and includes a red color filter, a green color filter and a blue color filter. Each of the red color filter, green color filter, and blue color filter includes first dielectric layers including a first material having a first refractive index and second dielectric layers including a second material having a second refractive index smaller than the first refractive index, the first dielectric layers and the second dielectric layers being alternately stacked. The sum of the number of the first dielectric layers and the number of the second dielectric layers in the red color filter is different from the sum of the number of the first dielectric layers and the number of the second dielectric layers in the green color filter.

### CROSS-REFERENCE TO RELATED APPLICATIONS

This U.S. non-provisional patent application claims priority under 35 U.S.C. §119 of Korean Patent Application No. 10-2014-0102465, filed on Aug. 8, 2014, the entire contents of which are hereby incorporated by reference.

### BACKGROUND

Currently known display devices include a liquid crystal display (LCD), a plasma display panel (PDP), an organic light emitting display (OLED), a field effect display (FED), and an eletrophoretic display (EPD).

In general, the display devices include a polarizer and their light transmission efficiency is low because considerable amount of light is lost while passing through the polarizer.

### SUMMARY

The present system and method provide a display device having high light transmission efficiency.

Embodiments of the present system and method provide display devices including: a backlight unit providing light; a color filter formed on the backlight unit and including a red color filter, a green color filter and a blue color filter; and a shutter panel facing the color filter, wherein the red color filter includes one or more first dielectric layers formed of at least a first material having a first refractive index and one or more second dielectric layers formed of at least a second material having a second refractive index smaller than the first refractive index, the first dielectric layers and the second dielectric layers being alternately stacked, the green color filter includes one or more third dielectric layers formed of at least the first material and one or more fourth dielectric layers formed of at least the second material, the third dielectric layer and the fourth dielectric layer being alternately stacked, the blue color filter includes one or more fifth dielectric layers formed of at least the first material and one or more sixth dielectric layers formed of at least the second material, the fifth dielectric layer and the sixth dielectric layer being alternately stacked, and the sum of the number of the first dielectric layers and the number of the second dielectric layers is different from the sum of the number of the third dielectric layers and the number of the fourth dielectric layers.

In some embodiments, the sum of the number of the first dielectric layers and the number of the second dielectric layers may be the same as the sum of the number of the fifth dielectric layers and the number of the sixth dielectric layers.

In other embodiments, the number of the first dielectric layers may be different from the number of the second dielectric layers, the number of the third dielectric layers may be different from the number of the fourth dielectric layers, and the number of the fifth dielectric layers may be different from the number of the sixth dielectric layers.

In still other embodiments, a layer having the maximum thickness among layers in the red color filter may be arranged between the outermost layers of the red color filter, a layer having the maximum thickness among layers in the green color filter may be arranged between the outermost layers of the green color filter, and a layer having the maximum thickness among layers in the blue color filter may be arranged between the outermost layers of the blue color filter.

In even other embodiments, the thickness of the green color filter may be thicker than the thickness of the red color filter, and the thickness of the blue color filter may be thicker than the thickness of the green color filter.

In yet other embodiments, the difference between the first refractive index and the second refractive index may be about 0.5 to about 1.5.

In further embodiments, the first material may be TiO2 and the second material may be SiO2.

In still further embodiments, the outermost layers of the red color filter may be the first dielectric layers, the outermost layers of the green color filter may be the third dielectric layers, and the outermost layers of the blue color filter may be the fifth dielectric layers.

In even further embodiments, a layer having the maximum thickness among layers in the red color filter may be the second dielectric layer, a layer having the maximum thickness among layers in the green color filter may be the fourth dielectric layer, and a layer having the maximum thickness among layers in the blue color filter may be the sixth dielectric layer.

In yet further embodiments, the backlight unit may provide a first light, the color filter may receive the first light, reflect at least a portion of the first light and emit a second light having a wavelength different from the reflected portion of the first light, the shutter panel may receive the second light from the color filter and transmit at least a portion of the second light, and the oscillation direction of the second light received from the color filter and the oscillation direction of the portion of the second light transmitted by the shutter panel are the same.

In yet other embodiments, the red color filter may emit red light, the green color filter may emit green light, the blue color filter may emit blue light, and the thickness L of the red color filter, the green color filter or the blue color filter may be determined by Equation 1 below:

$$∠ = {N}_{1} \frac{λ}{{n}_{1}} + {N}_{2} \frac{λ}{{n}_{2}} \qquad 〈 Equation 1 〉$$

where n1 is the first refractive index, n2 is the second refractive index, N1 is the number of the first dielectric layers, the number of the third dielectric layers, or the number of the fifth dielectric layers, N2 is the number of the second dielectric layers, the number of the fourth dielectric layers, or the number of the sixth dielectric layers, λ is the wavelength of red light, the wavelength of green light or the wavelength of blue light.

In yet other embodiments, the thickness Lₘₐₓ of a layer having the maximum thickness among layers in the red color filter, the thickness Lₘₐₓ of a layer having the maximum thickness among layers in the green color filter, or the thickness Lₘₐₓ of a layer having the maximum thickness among layers in the blue color filter may be determined by Equation 2 below:

$${∠}_{max} < \frac{λ N}{2} ( \frac{1}{{n}_{1}} + \frac{1}{{n}_{2}} ) \qquad 〈 Equation 2 〉$$

where n1 is the first refractive index, n2 is the second refractive index, N is the sum of the number of the first dielectric layers and the number of the second dielectric layers, the sum of the number of the third dielectric layers and the number of the fourth dielectric layers, or the sum of the number of the fifth dielectric layers and the number of the sixth dielectric layers, and λ is the wavelength of red light, the wavelength of green light or the wavelength of blue light.

In yet other embodiments, an emission angle of the first light may be about −20° to about +20°.

In yet other embodiments, the shutter panel may be at least one of a micro electro mechanical systems (MEMS) shutter panel, a liquid switch shutter panel, and a reflective polymer dispersed liquid crystal (PDLC) shutter panel.

In yet other embodiments, the shutter panel may include: a shutter transmitting at least a portion of the second light received from the color filter; and a switching element providing the shutter with an image signal voltage to change the light transmittance of the shutter.

In yet other embodiments, the backlight unit may include: a light unit emitting the first light; and a light guide plate guiding the first light received from the light unit to emit the first light.

In yet other embodiments, the display device may further include a diffusion sheet diffusing the second light passing through the shutter panel wherein the diffusion sheet is formed on the shutter panel.

In yet other embodiments, each of the sum of the number of the first dielectric layers and the number of the second dielectric layers, the sum of the number of the third dielectric layers and the number of the fourth dielectric layers and the sum of the number of the fifth dielectric layers and the number of the sixth dielectric layers may be an odd number.

In yet other embodiments, the number of the first dielectric layers may be ten, the number of the second dielectric layers may be nine, the number of the third dielectric layers may be thirteen, the number of the fourth dielectric layers may be twelve, the number of the fifth dielectric layers may be ten, and the number of the sixth dielectric layers may be nine.

In yet other embodiments, the first and second dielectric layers in the red color filter may be different from one another in thickness, the first and fourth dielectric layers in the green color filter may be different from one another in thickness, and the first and sixth dielectric layers in the blue color filter may be different from one another in thickness.

### BRIEF DESCRIPTION OF THE DRAWINGS

The accompanying drawings illustrate exemplary embodiments of the present system and method and, together with the description, serve to explain the principles of the present system and method. In the drawings:

FIG. 1 is a schematic exploded perspective view of a display device according to an embodiment of the present system and method;

FIG. 2 is a schematic exploded plan view of a display device according to an embodiment of the present system and method;

FIG. 3 is a schematic plan view of a backlight unit in a display device according to an embodiment of the present system and method;

FIGS. 4A and 4B respectively are schematic plan views of a shutter panel in a display device according to an embodiment of the present system and method;

FIGS. 5A and 5B respectively are schematic plan views of a shutter panel in a display device according to an embodiment of the present system and method;

FIGS. 6A and 6B respectively are schematic plan views of a color filter in a display device according to an embodiment of the present system and method;

FIG. 7 is a graph of wavelength vs. transmittance in a color filter of Embodiment 1;

FIG. 8A is a graph of wavelength vs. transmittance in a red color filter of Embodiment 1;

FIG. 8B is a graph of wavelength vs. transmittance in a green color filter of Embodiment 1;

FIG. 8C is a graph of wavelength vs. transmittance in a blue color filter of Embodiment 1;

FIG. 9A is a graph of wavelength vs. transmittance in a red color filter of Embodiment 2;

FIG. 9B is a graph of wavelength vs. transmittance in a green color filter of Embodiment 2; and

FIG. 9C is a graph of wavelength vs. transmittance in a blue color filter of Embodiment 2.

### DETAILED DESCRIPTION

Embodiments of the present system and method are described with reference to the accompanying drawings. However, the present system and method are not limited to these embodiments described below but may be implemented in other forms.

In describing each drawing, similar reference numerals are used for similar components. The dimensions of the structures shown in the accompanying drawings are exaggerated for clarity. Unless otherwise specified, the terms “first” and “second” are used herein to describe various components and only serve to distinguish one component from another component. The components are not otherwise limited by these terms. For example, a first component may be called a second component and similarly, the second component may also be called the first component. The terms in singular form include the plural form unless otherwise specified.

As used herein, the terms “includes” or “has” indicate the presence of characteristics, numbers, steps, operations, components, parts or combinations thereof represented in the present disclosure but do not exclude the presence or addition of one or more other characteristics, numbers, steps, operations, components, parts or combinations thereof. Also, when a component such as a layer, a film, an area, or a plate is referred to as being “on” another component, it may be directly on the other component or intervening components may be present in between. Similarly, when a component such as a layer, a film, an area, or a plate is referred to as being “under” another component, it may be directly under the other component or intervening components may be present in between.

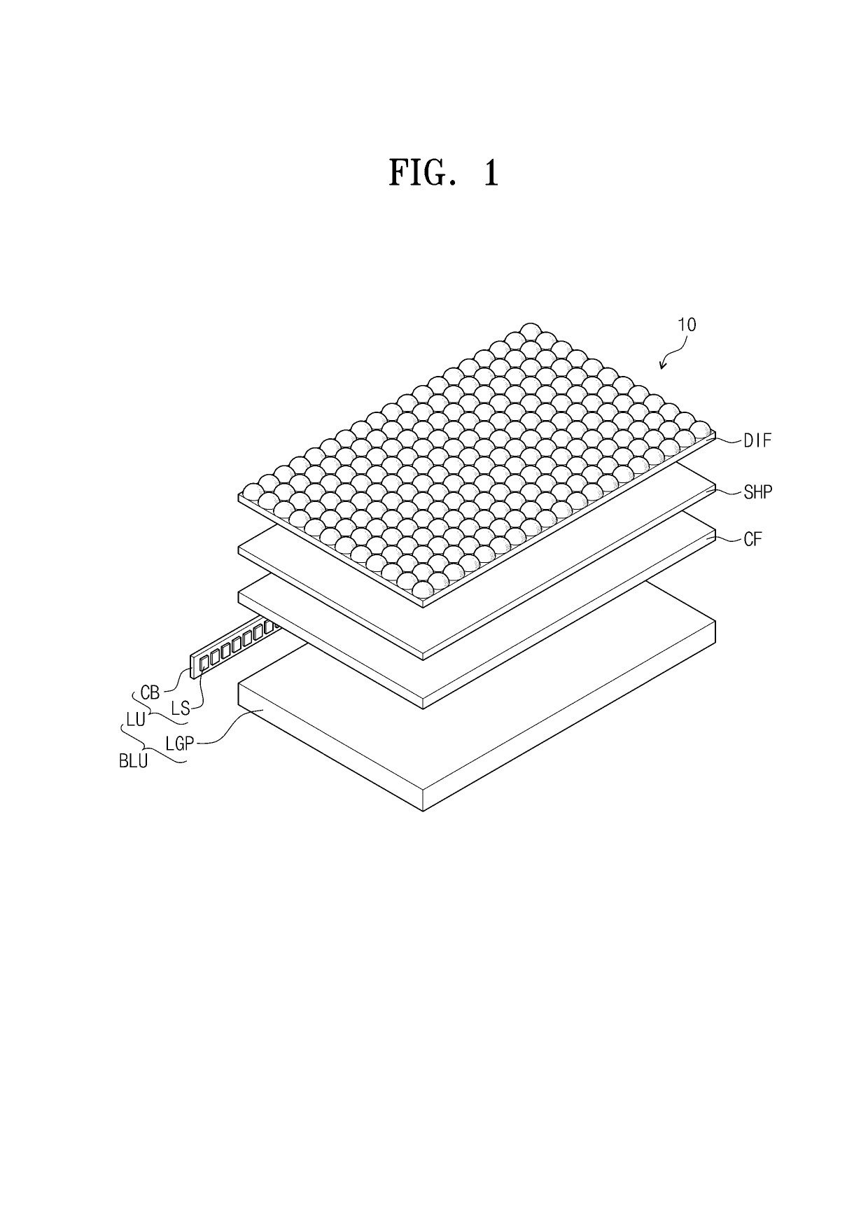

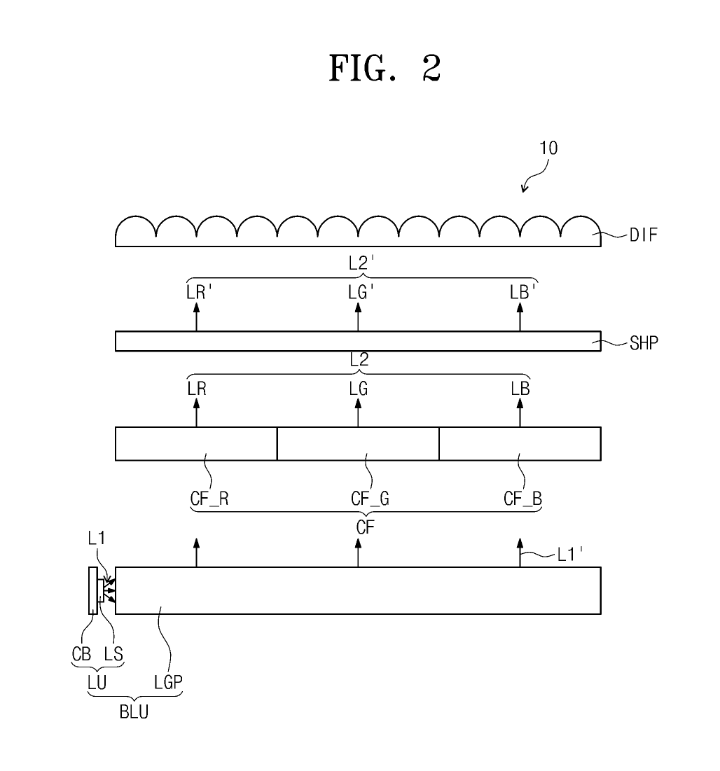

In the following, a display device according to an embodiment of the present system and method is described. FIG. 1 is a schematic exploded perspective view of a display device according to an embodiment of the present system and method. FIG. 2 is a schematic exploded plan view of a display device according to an embodiment of the present system and method.

Referring to FIGS. 1 and 2, a display device 10 according to an embodiment of the present system and method includes a backlight unit BLU, a color filter CF and a shutter panel SHP.

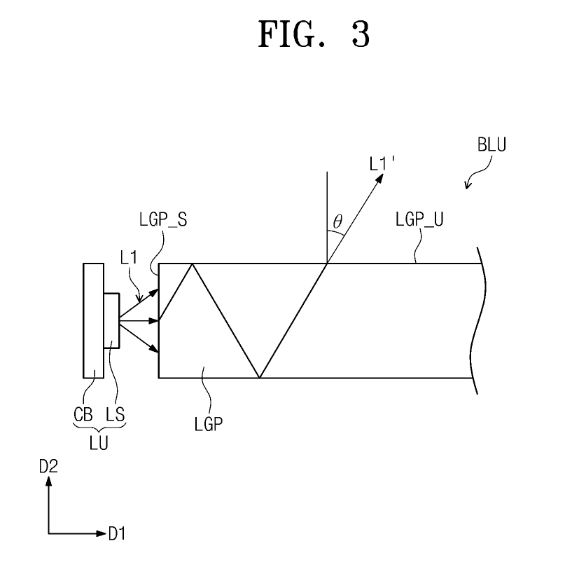

The backlight unit BLU provides the color filter CF with light. The backlight unit BLU may include a light unit LU and a light guide plate LGP. The light unit LU may hold at least one light source LS on its one surface and include a circuit substrate CS that applies power to the light source LS. The light source LS may include a plurality of light emitting diodes (LEDs). The LEDs may be arranged at distance intervals from one another on the circuit substrate CS. The light unit LU may be arranged a distance apart from a side of the light guide plate LGP in a first direction (e.g., D1 in FIG. 3).

As FIG. 2 shows, the light unit LU emits a first light L1 to the light guide panel LGP. The light guide plane guides the first light L1 provided from the light unit LU and emits it as a first light L1′. The first light L1 and L1′ may be white light in one example. However, the present system and method are not limited thereto and the first light L1 or L1′ may be blue light LB in another example.

The color filter CF in FIG. 1 is formed between the backlight unit BLU and the shutter panel SHP. Although FIG. 1 describes an example in which the color filter CF is formed between the backlight unit BLU and the shutter panel SHP, the present system and method are not limited thereto and the color filter CF may be formed on the shutter panel SHP in another example.

The color filter CF in FIG. 2 receives the first light L1′, reflects at least a portion of the first light L1′ and emits second light L2 having a wavelength different from the first light L1′. The second light L2 may be red light LR, green light LG or blue light LB, for example. The wavelength of the red light LR may be, for example, about 600 nm to about 700 nm. The wavelength of the green light LG may be, for example, about 500 nm to about 580 nm. The wavelength of the blue light LB may be, for example, about 400 nm to 490 nm.

The color filter CF in FIG. 2 includes a red color filter CF_R, a green color filter CF_G, and a blue color filter CF_B. The color filter CF is described below in more detail.

FIG. 3 is a schematic plan view of a backlight unit BLU in the display device 10 according to an embodiment of the present system and method. Referring to FIG. 3, the light guide plate LGP guides the first light L1 provided from the light unit LU to emit light L1′. The light guide plate LGP includes an incident surface LGP_S that receives the first light L1 from the light unit LU and an emitting surface LGP_U that emits the first light L1′.

The first light L1′ emitted from the light guide plate LGP may have an emission angle θ of about −20° to about +20°. Referring to FIG. 3, the emission angle θ may be, for example, an angle that the first light L1′ emitted from the emitting surface LGP_U makes with the thickness direction (e.g., D2 in FIG. 3) of the light guide plate LGP. That is, the emission angle θ of the first light L1′ may be measured with respect to an axis perpendicular to the emitting surface LGP_U.

The shutter panel SHP in FIG. 2 faces and receives the second light L2 from the color filter CF. The shutter panel SHP transmits at least a portion of the received second light L2 as second light L2′.

According to an embodiment of the present system and method, the shutter panel SHP maintains the polarity of the incoming light in its transmitted light. That is, in the case shown in FIG. 2, the oscillation direction of the second light L2 provided from the color filter CF is the same as that of the second light L2′ passing through the shutter panel SHP. For example, if the second light L2 provided from the color filter CF is unpolarized light, the second light L2′ passing through the shutter panel SHP is also unpolarized light. If the second light L2 provided from the color filter CF is polarized light, the second light L2′ passing through the shutter panel SHP is also polarized light.

According to an embodiment of the present system and method, the shutter panel SHP may include at least one of a micro electro mechanical systems (MEMS) shutter panel SHP, a liquid switch shutter panel SHP, and a reflective polymer dispersed liquid crystal (PDLC) shutter panel SHP without a special limitation.

Because the display device 10 according to an embodiment of the present system and method includes the shutter panel SHP, which maintains the polarization of the incoming light in its transmitted light, light loss due to polarization is prevented. Thus, the display device 10 according to an embodiment of the present system and method increases light efficiency.

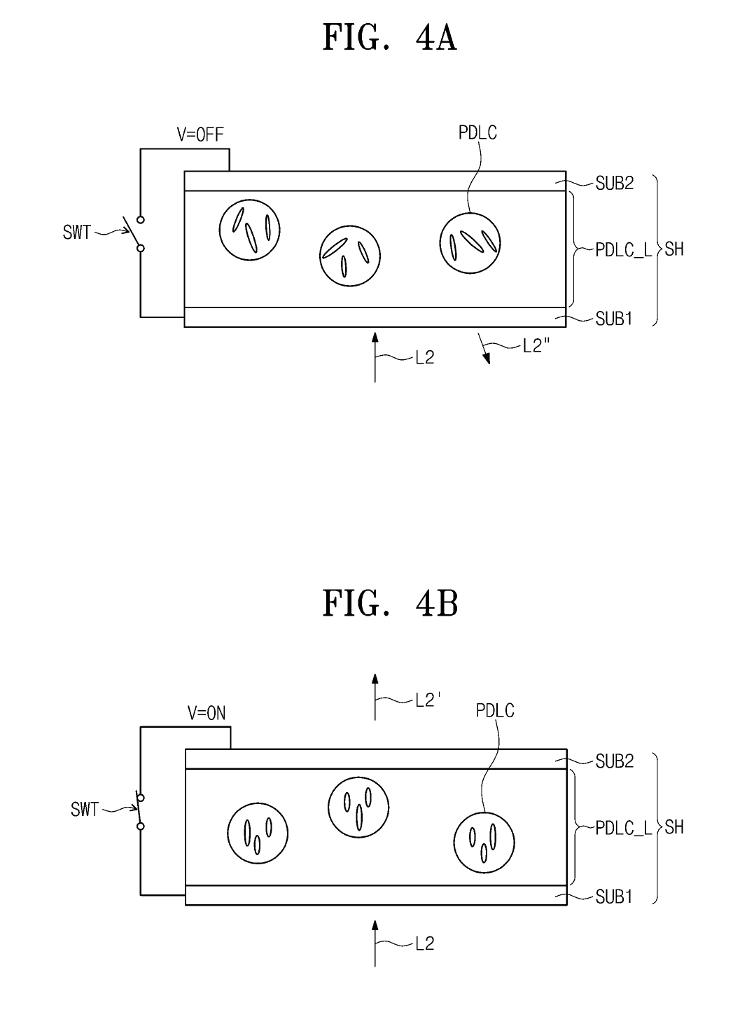

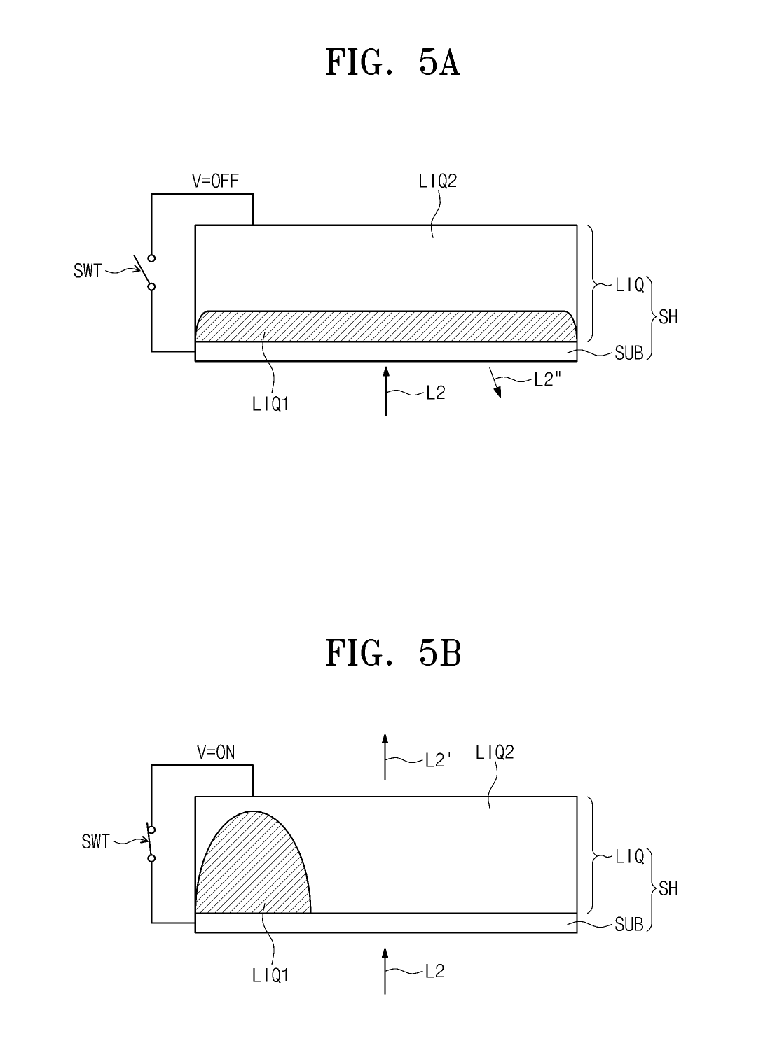

FIGS. 4A and 4B respectively are schematic plan views of a shutter panel in a display device according to an embodiment of the present system and method. FIGS. 5A and 5B respectively are schematic plan views of a shutter panel in a display device according to another embodiment of the present system and method. Referring to FIGS. 4A to 5B, the shutter panel SHP may include a switching element SWT that provides a shutter SH with an image signal voltage V to control the shutter SH.

Referring to FIGS. 4A and 4B, the shutter SH may include a first substrate SUB1, a second substrate SUB2 facing the first substrate SUB1, and a reflective polymer dispersed liquid crystal layer PDLC_L including reflective polymer dispersed liquid crystals (PDLCs) whose orientation may change by application of the image signal voltage V. The switching element SWT is connected to each of the first substrate SUB1 and the second substrate SUB2 by an interconnection. The first substrate SUB1 and the second substrate SUB2 may be transparent. The first substrate SUB1 or the second substrate SUB2 may be provided with the image signal voltage V.

FIG. 4A illustrates an image signal voltage off V=OFF state in which the switching element SWT is OFF and the first substrate SUB1 and the second substrate SUB2 are not provided with the image signal voltage V. In the image signal voltage off V=OFF state, the reflective polymer dispersed liquid crystals PDLCs are non-uniformly arranged in its directionality. In this way, the second light L2 provided from the color filter CF (in FIG. 1) is reflected by the reflective polymer dispersed liquid crystals PDLCs as reflected light L2″.

FIG. 4B illustrates an image signal voltage on V=ON state in which the switching element SWT is ON and the first substrate SUB1 or the second substrate SUB2 is provided with the image signal voltage V. In the image signal voltage on V=ON state, the reflective polymer dispersed liquid crystals PDLCs are uniformly arranged in a determined direction due to the effects of an electric field formed by a first electrode (not shown) in the first substrate SUB1 and a second electrode (not shown) in the second substrate SUB2. In this way, the second light L2 provided from the color filter CF (in FIG. 1) passes through the reflective polymer dispersed liquid crystal layer PDLC_L as transmitted light L2′.

Referring to FIGS. 5A and 5B, the shutter SH may include a substrate SUB, and a liquid layer LIQ that includes a first liquid LIQ1 and a second liquid LIQ2. The shape of the first liquid LIQ1 may change by application of the image signal voltage V. The second liquid LIQ2 may differ from the first liquid LIQ1 in that the shape of the second liquid LIQ2 is not affected by application of the image signal voltage V. The first liquid LIQ1 may absorb or reflect the second light and the second liquid LIQ2 may transmit the second light. The switching element SWT is connected to the substrate SUB and the liquid layer LIQ by an interconnection. Although FIGS. 5A and 5B describe an example in which the liquid layer LIQ is formed on the substrate SUB, the present system and method are not limited thereto and the liquid layer LIQ may be formed between the first substrate (not shown) and the second substrate (not shown) in another example. In the latter example, the first substrate (not shown) and the second substrate (not shown) may be connected to the switching element SWT by an interconnection.

FIG. 5A illustrates an image signal voltage off V=OFF state in which the switching element SWT is OFF and the LIQ and substrate SUB are not provided with the image signal voltage V. In the image signal voltage off V=OFF state, because no voltage polarity is formed on a switching electrode (not shown) disposed at a portion of the substrate SUB, the first liquid LIQ1 does not gravitate towards the switching electrode (such as shown in FIG. 5B). Instead, the first liquid LIQ1 is dispersed and distributed over the substrate SUB. In this way, the second light L2 provided from the color filter CF (in FIG. 1) does not pass through the liquid layer LIQ but is absorbed or reflected by the first liquid LIQ1 as reflected light L2″.

FIG. 5B illustrates an image signal voltage on V=ON state in which the switching element SWT is ON and the substrate SUB is provided with the image signal voltage V. In the image signal voltage on V=ON state, because a voltage polarity is formed on a switching electrode (not shown) formed at a portion of the substrate SUB, the first liquid LIQ1 gravitates towards the switching electrode, thereby changing the shape of the first liquid LIQ1. Although not shown in FIG. 5B, the switching electrode may be disposed on the left side of the substrate SUB. When the switching element SWT is ON and the substrate SUB is provided with the image signal voltage V, a voltage polarity is generated in the switching electrode, which may cause the first liquid LIQ1 to move onto the switching electrode and displace a portion of the second liquid LIQ2. Some of the second liquid LIQ may move to the region where the first liquid LIQ1 moved from. Since the first liquid LIQ1 shown in FIG. 5B no longer covers all of the substrate SUB, the second light L2 provided from the color filter CF (in FIG. 1) may pass through the liquid layer LIQ as transmitted light L2′. That is, in the image signal voltage on V=ON state, portions of the substrate SUB that are free from overlap with the first liquid LIQ1 may allow the second light L2 to be transmitted.

Referring back to FIGS. 4A to 5B, the shutter SH may be provided to overlap with each of the color filters, such as the red color filter CF_R, the green color filter CF_G, and the blue color filter CF_B shown in FIG. 1. In the case shown in FIG. 1, the shutter SH overlapping with the red color filter CF_R transmits red light LR (in FIG. 1), the shutter SH overlapping with the green color filter CF_G transmits green light LG, and the shutter SH overlapping with the blue color filter CF_B transmits blue light LB.

Referring back to FIGS. 1 and 2, the display device 10 according to an embodiment of the present system and method may further include a diffusion sheet DIF formed on the shutter panel SHP. The diffusion sheet DIF diffuses the second light L2′ passing through the shutter panel SHP. The diffusion sheet DIF may be located at the top of the display device 10 and have an uneven shape, so as to widen a viewing angle and minimize an image characteristic decrease and grayscale inversion, which may depend on the location of an observer. This allows the same image to be observed at various angles.

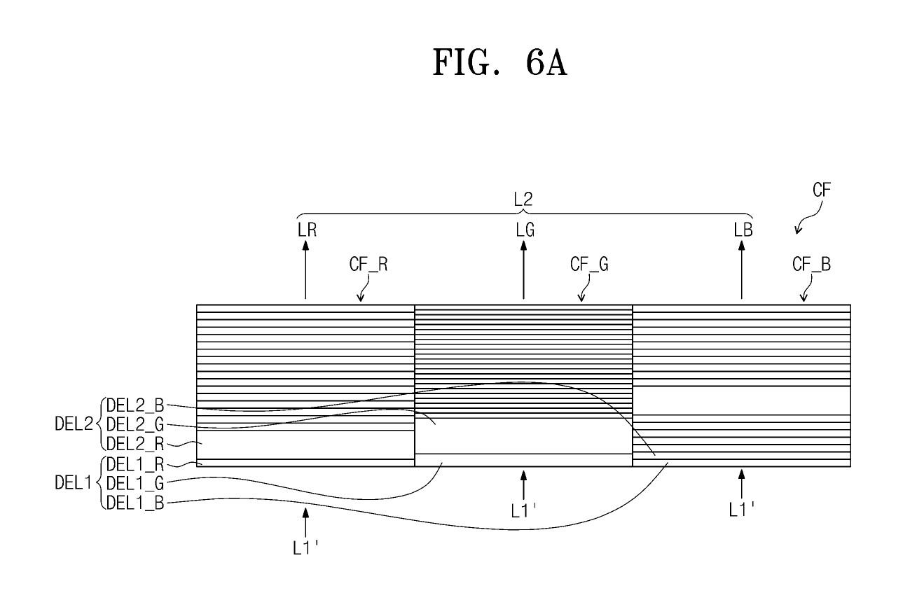

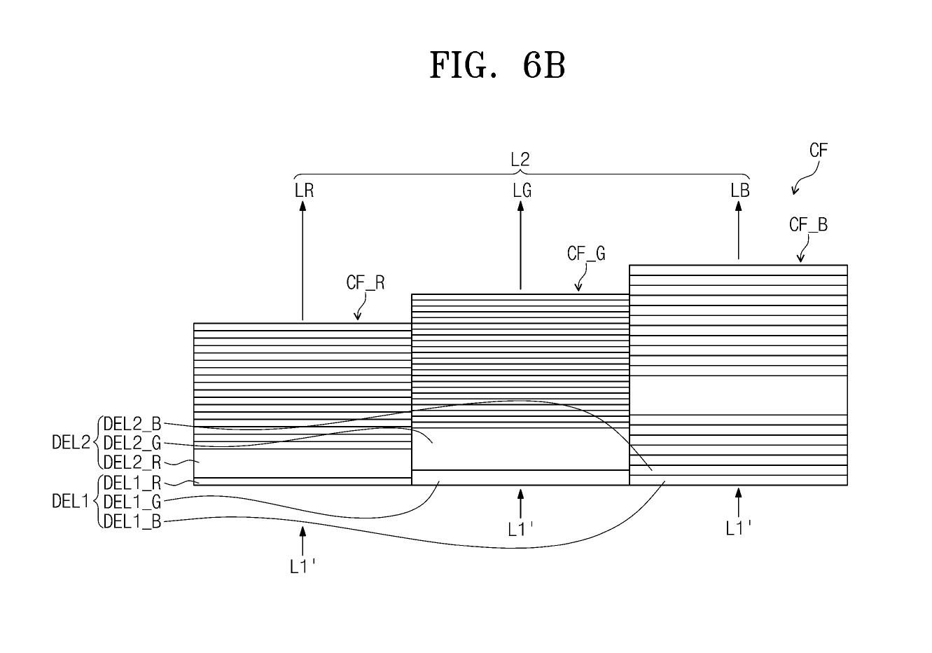

FIGS. 6A and 6B respectively are schematic plan views of a color filter in a display device according to an embodiment of the present system and method. Referring to FIGS. 1, 2, 6A and 6B, the color filter CF includes the red color filter CF_R, the green color filter CF_G, and the blue color filter CF_B as described above.

FIG. 6A illustrates an embodiment in which the thickness of the red color filter CF_R, the thickness of the green color filter CF_G, and the thickness of the blue color filter CF_B are the same. FIG. 6B illustrates another embodiment in which the thickness of the green color filter CF_G is thicker than that of the red color filter CF_R, and the thickness of the blue color filter CF_B is thicker than that of the green color filter CF_G. As an example of the latter embodiment, the thickness of the red color filter CF_R may be about 1.239 μm, the thickness of the green color filter CF_G may be about 1.513 μm, and the thickness of the blue color filter CF_B may be about 1.664 μm. However, the present system and method are not limited thereto. In another embodiment (not shown), two of the red color filter CF_R, the green color filter CF_G, and the blue color filter CF_B may have the same thickness.

Referring to FIGS. 6A and 6B, each of the red color filter CF_R, the green color filter CF_G and the blue color filter CF_B includes a first dielectric layer DEL1 and a second dielectric layer DEL2. The first dielectric layer DEL1 includes a first dielectric layer DEL1_R, a third dielectric layer DEL1_G, and a fifth dielectric layer DEL1_B. The second dielectric layer DEL2 includes a second dielectric layer DEL2_R, a fourth dielectric layer DEL2_G, and a sixth dielectric layer DEL2_B.

According to an embodiment, the first dielectric layer DEL1 includes a first material having a first refractive index. The first material may be TiO₂, for example. The second dielectric layer DEL2 includes a second material having a second refractive index smaller than the first refractive index. The second material may be SiO₂, for example.

The difference between the first refractive index and the second refractive index may be about 0.5 to about 1.5. If the difference between the first refractive index and the second refractive index is less than about 0.5, it may be difficult to receive the first light L1 from the backlight unit BLU and emit the second light having a wavelength different from the first light L1. If the difference between the first refractive index and the second refractive index exceeds about 1.5, excess light loss due to the difference in refractive index may occur.

The display device 10 according to an embodiment of the present system and method alternately stacks dielectric layers having different refractive indices to form the color filters CF, such as the red color filter, the green color filter CF_G, and the blue color filter CF_B shown in FIGS. 6A and 6B. Because each of the first dielectric layer DEL1 and the second dielectric layer DEL2 varies in its refractive index for a given wavelength, by alternately stacking the first dielectric layer DEL1 and the second dielectric layer DEL2 and adjusting the thickness of the first dielectric layer DEL1 and the thickness of the second dielectric layer DEL2, it is possible to form color filters CF that transmit various colors of light, including the red color filter that receives the first light L1′ and emits the red light LR, the green color filter CF_G that receives the first light L1′ and emits the green light LG, and the blue color filter CF_B that receives the first light L1′ and emits the blue light LB.

The thickness L of the color filter CF may be determined by Equation 1 below.

$$∠ = {N}_{1} \frac{λ}{{n}_{1}} + {N}_{2} \frac{λ}{{n}_{2}} \qquad 〈 Equation 1 〉$$

In Equation 1, n1 is a first refractive index, n2 is a second refractive index, N1 is the number of first dielectric layers DEL1, N2 is the number of second dielectric layers DEL2, λ is the wavelength of the light to be transmitted (e.g., red light LR, green light LG or blue light).

For example, if the thickness of the red color filter CF_R is determined by Equation 1 above, N1 is the number of the first dielectric layers DEL1_R, N2 is the number of the second dielectric layers DEL2_R, and λ is the wavelength of the red light LR. Similarly, if the thickness of the green color filter CF_G is indicated by Equation 1 above, N1 is the number of the third dielectric layers DEL1_G, N2 is the number of the fourth dielectric layers DEL2_G, and λ is the wavelength of the green light LG. Likewise, if the thickness of the blue color filter CF_B is indicated by Equation 1 above, N1 is the number of the fifth dielectric layers DEL1_B, N2 is the number of the sixth dielectric layers DEL2_B, and λ is the wavelength of the blue light LB.

According to an embodiment, the red color filter CF_R includes a plurality of first dielectric layers DEL1_R and a plurality of second dielectric layers DEL2_R that are alternately stacked. Each of the outermost layers of the red color filter CF_R may be a first dielectric layer DEL1_R. That is, the first and last dielectric layers in the stack may be a first dielectric layer DEL1_R.

The sum of the number of the first dielectric layers DEL1_R and the number of the second dielectric layers DEL2_R may be an odd number. Meaning, the number of the first dielectric layers DEL1_R may be different from the number of the second dielectric layers DEL2_R. The number of the first dielectric layers DEL1_R may be larger than the number of the second dielectric layers DEL2_R.

Each of the layers in the red color filter CF_R may have a different thickness. A layer having the maximum thickness among the layers in the red color filter CF_R may be a second dielectric layer DEL2_R. A layer having the maximum thickness among layers in the red color filter CF_R may be arranged between the outermost layers of the red color filter CF_R.

Table 1 below illustrates the thicknesses of the first dielectric layer DEL1_R and the second dielectric layer DEL2_R in the red color filter CF_R, according to an embodiment in which the first dielectric layers DEL1_R and the second dielectric layers DEL2_R are alternately, sequentially stacked in the thickness direction (e.g., D2 in FIG. 3) of the display device 10 in order from upper layer No. 1 to lower layer No. 19.

TABLE 1

| No. | Layer | Material | Thickness (nm) |
|---|---|---|---|
| 1 | First dielectric layer | TiO₂ | 3.96E−02 |
| 2 | Second dielectric layer | SiO₂ | 2.89E−02 |
| 3 | First dielectric layer | TiO₂ | 5.67E−02 |
| 4 | Second dielectric layer | SiO₂ | 9.62E−02 |
| 5 | First dielectric layer | TiO₂ | 4.54E−02 |
| 6 | Second dielectric layer | SiO₂ | 1.00E−02 |
| 7 | First dielectric layer | TiO₂ | 5.21E−02 |
| 8 | Second dielectric layer | SiO₂ | 9.15E−02 |
| 9 | First dielectric layer | TiO₂ | 4.36E−02 |
| 10 | Second dielectric layer | SiO₂ | 0.055245988 |
| 11 | First dielectric layer | TiO₂ | 4.79E−02 |
| 12 | Second dielectric layer | SiO₂ | 0.1000313 |
| 13 | First dielectric layer | TiO₂ | 6.51E−02 |
| 14 | Second dielectric layer | SiO₂ | 0.1036259 |
| 15 | First dielectric layer | TiO₂ | 5.74E−02 |
| 16 | Second dielectric layer | SiO₂ | 0.04036402 |
| 17 | First dielectric layer | TiO₂ | 4.35E−02 |
| 18 | Second dielectric layer | SiO₂ | 0.1265882 |
| 19 | First dielectric layer | TiO₂ | 6.59E−02 |

Referring to Table 1 above, the red color filter CF_R may include ten first dielectric layers DEL1_R and nine second dielectric layers DEL2_R. The ten first dielectric layers DEL1_R and the nine second dielectric layers DEL2_R are alternately, sequentially stacked in order from lower layer No. 19 to upper layer No. 1. In this case, the second dielectric layer DEL2_R corresponding to layer No. 18 in the red color filter CF_R has the maximum thickness. The first dielectric layers DEL1_R corresponding to layers No. 1 and No. 19 are arranged as the outermost layers of the red color filter CF_R.

Although not shown, an upper red color filter thickness adjusting layer may be formed on the first dielectric layer DEL1_R corresponding to layer No. 1 so as to adjust the overall thickness of the red color filter CF_R. Likewise, a lower red color filter thickness adjusting layer may be formed under the first dielectric layer DEL1_R corresponding to layer No. 19 so as to adjust the overall thickness of the red color filter CF_R. Each of the upper red color filter thickness adjusting layer and the lower red color filter thickness adjusting layer may be formed of the same material as a second dielectric layer. For example, each of the upper red color filter thickness adjusting layer and the lower red color filter thickness adjusting layer may be formed of SiO₂.

According to an embodiment, the green color filter CF_G includes a plurality of third dielectric layers DEL1_G and a plurality of fourth dielectric layers DEL2_G that are alternately stacked. Each of the outermost layers of the green color filter CF_G may be a third dielectric layer DEL1_G. That is, the first and last dielectric layers in the stack may be a third dielectric layer DEL1_G.

The sum of the number of the third dielectric layers DEL1_G and the number of the fourth dielectric layers DEL2_G may be an odd number. Meaning, the number of the third dielectric layers DEL1_G may be different from the number of the fourth dielectric layers DEL2_G. The number of the third dielectric layers DEL1_G may be larger than the number of the fourth dielectric layers DEL2_G.

Each of the layers in the green color filter CF_G may have a different thickness. A layer having the maximum thickness among the layers in the green color filter CF_G may be a fourth dielectric layer DEL2_G. A layer having the maximum thickness among layers in the green color filter CF_G may be arranged between the outermost layers of the green color filter CF_G.

Table 2 below illustrates the thicknesses of the third dielectric layer DEL1_G and the fourth dielectric layer DEL2_G in the green color filter CF_G, according to an embodiment in which the third dielectric layers DEL1_G and the fourth dielectric layers DEL2_G are alternately, sequentially stacked in the thickness direction (e.g., D2 in FIG. 3) of the display device 10 in order from lower layer No. 25 to upper layer No. 1.

TABLE 2

| No. | Layer | Material | Thickness (nm) |
|---|---|---|---|
| 1 | Third dielectric layer | TiO₂ | 56.441054 |
| 2 | Fourth dielectric layer | SiO₂ | 33.206359 |
| 3 | Third dielectric layer | TiO₂ | 37.682876 |
| 4 | Fourth dielectric layer | SiO₂ | 78.27048 |
| 5 | Third dielectric layer | TiO₂ | 44.452861 |
| 6 | Fourth dielectric layer | SiO₂ | 68.958715 |
| 7 | Third dielectric layer | TiO₂ | 49.669906 |
| 8 | Fourth dielectric layer | SiO₂ | 86.785242 |
| 9 | Third dielectric layer | TiO₂ | 29.741868 |
| 10 | Fourth dielectric layer | SiO₂ | 35.550699 |
| 11 | Third dielectric layer | TiO₂ | 58.199778 |
| 12 | Fourth dielectric layer | SiO₂ | 100.0816 |
| 13 | Third dielectric layer | TiO₂ | 67.86193 |
| 14 | Fourth dielectric layer | SiO₂ | 102.7357 |
| 15 | Third dielectric layer | TiO₂ | 10.000184 |
| 16 | Fourth dielectric layer | SiO₂ | 10.005251 |
| 17 | Third dielectric layer | TiO₂ | 83.279952 |
| 18 | Fourth dielectric layer | SiO₂ | 105.1478 |
| 19 | Third dielectric layer | TiO₂ | 65.074161 |
| 20 | Fourth dielectric layer | SiO₂ | 95.702752 |
| 21 | Third dielectric layer | TiO₂ | 10.000125 |
| 22 | Fourth dielectric layer | SiO₂ | 10.017142 |
| 23 | Third dielectric layer | TiO₂ | 77.521756 |
| 24 | Fourth dielectric layer | SiO₂ | 130.1002 |
| 25 | Third dielectric layer | TiO₂ | 66.912681 |

Referring to Table 2 above, the green color filter CF_G may include thirteen third dielectric layers DEL1_G and twelve fourth dielectric layers DEL2_G. The thirteen third dielectric layers DEL1_G and the twelve fourth dielectric layers DEL2_G are alternately, sequentially stacked in order from lower layer No. 25 to upper layer No. 1. Referring to Table 2, the fourth dielectric layer DEL2_R corresponding to layer No. 24 in the green color filter CF_G has the maximum thickness. The third dielectric layers DEL1_G corresponding to layers No. 1 and No. 2 are arranged as the outermost layers of the green color filter CF_G.

Although not shown, an upper green color filter thickness adjusting layer may be formed on the third dielectric layer DEL1_G corresponding to layer No. 1 so as to adjust the overall thickness of the green color filter CF_G. Likewise, a lower green color filter thickness adjusting layer may be formed under the third dielectric layer DEL1_G corresponding to layer No. 25 so as to adjust the thickness of the green color filter CF_G. Each of the upper green color filter thickness adjusting layer and the lower green color filter thickness adjusting layer may be formed of the same material as a fourth dielectric layer. For example, each of the upper green color filter thickness adjusting layer and the lower green color filter thickness adjusting layer may be formed of SiO₂.

According to an embodiment, the blue color filter CF_B includes a plurality of fifth dielectric layers DEL1_B and a plurality of sixth dielectric layers DEL2_B that are alternately stacked. Each of the outermost layers of the blue color filter CF_B may be a fifth dielectric layer DEL1_B. That is, the first and last dielectric layers in the stack may be a fifth dielectric layer DEL1_B.

The sum of the number of the fifth dielectric layers DEL1_B and the number of the sixth dielectric layers DEL2_B may be an odd number. Meaning, the number of the fifth dielectric layers DEL1_B may be different from the number of the sixth dielectric layers DEL2_B. The number of the fifth dielectric layers DEL1_B may be larger than the number of the sixth dielectric layers DEL2_B.

Each of the layers in the blue color filter CF_B may have a different thickness. A layer having the maximum thickness among the layers in the blue color filter CF_B may be a sixth dielectric layer DEL2_B. A layer having the maximum thickness among layers in the blue color filter CF_B may be arranged between the outermost layers of the blue color filter CF_B.

Table 3 below illustrates the thicknesses of the fifth dielectric layer DEL1_B and the sixth dielectric layer DEL2_B in the blue color filter CF_B, according to an embodiment in which the fifth dielectric layers DEL1_B and the sixth dielectric layers DEL2_B are alternately, sequentially stacked in the thickness direction (e.g., D2 in FIG. 3) of the display device 10 in order from lower layer No. 19 to upper layer No. 1.

TABLE 3

| No. | Layer | Material | Thickness (nm) |
|---|---|---|---|
| 1 | Fifth dielectric layer | TiO₂ | 1.00E−02 |
| 2 | Sixth dielectric layer | SiO₂ | 0.1458629 |
| 3 | Fifth dielectric layer | TiO₂ | 4.95E−02 |
| 4 | Sixth dielectric layer | SiO₂ | 0.1387454 |
| 5 | Fifth dielectric layer | TiO₂ | 4.91E−02 |
| 6 | Sixth dielectric layer | SiO₂ | 9.00E−02 |
| 7 | Fifth dielectric layer | TiO₂ | 1.00E−02 |
| 8 | Sixth dielectric layer | SiO₂ | 0.1706269 |
| 9 | Fifth dielectric layer | TiO₂ | 5.03E−02 |
| 10 | Sixth dielectric layer | SiO₂ | 9.79E−02 |
| 11 | Fifth dielectric layer | TiO₂ | 7.07E−02 |
| 12 | Sixth dielectric layer | SiO₂ | 0.1018208 |
| 13 | Fifth dielectric layer | TiO₂ | 5.59E−02 |
| 14 | Sixth dielectric layer | SiO₂ | 0.133206 |
| 15 | Fifth dielectric layer | TiO₂ | 7.20E−02 |
| 16 | Sixth dielectric layer | SiO₂ | 0.1534191 |
| 17 | Fifth dielectric layer | TiO₂ | 5.51E−02 |
| 18 | Sixth dielectric layer | SiO₂ | 0.1355319 |
| 19 | Fifth dielectric layer | TiO₂ | 6.06E−02 |

Referring to Table 3 above, the blue color filter CF_B may include ten fifth dielectric layers DEL1_B and nine sixth dielectric layers DEL2_B. The ten fifth dielectric layers DEL1_B and the nine sixth dielectric layers DEL2_B are alternately, sequentially stacked in order from lower layer No. 19 to upper layer No. 1. Referring to Table 3, the sixth dielectric layer DEL2_B corresponding to layer No. 8 in the blue color filter CF_B has the maximum thickness. The fifth dielectric layers DEL1_B corresponding to No. 1 and No. 19 are arranged as the outermost layers of the blue color filter CF_B.

Although not shown, an upper blue color filter thickness adjusting layer may be formed on the fifth dielectric layer DEL1_B corresponding to layer No. 1 so as to adjust the thickness of the blue color filter CF_B. Likewise, a lower blue color filter thickness adjusting layer CF_B may be formed under the fifth dielectric layer DEL1_B corresponding to layer No. 19 so as to adjust the thickness of the blue color filter CF_B. Each of the upper blue color filter thickness adjusting layer and the lower blue color filter thickness adjusting layer may be formed of the same material as a sixth dielectric layer. For example, each of the upper blue color filter thickness adjusting layer and the lower blue color filter thickness adjusting layer may be formed of SiO₂.

The thickness Lₘₐₓ of a layer having the maximum thickness among the layers in the color filter CF may be determined by Equation 2 below.

$${∠}_{max} < \frac{λ N}{2} ( \frac{1}{{n}_{1}} + \frac{1}{{n}_{2}} ) \qquad 〈 Equation 2 〉$$

In Equation 2, n1 is a first refractive index, n2 is a second refractive index, N is the sum of the number of first dielectric layers DEL1 and the number of second dielectric layers DEL2, and λ is the wavelength of the light being transmitted by the color filter (e.g., red light LR, green light LG or blue light LB).

For example, if the thickness of a layer having the maximum thickness among layers in the red color filter CF_R is indicated by Equation 2 above, N is the sum of the number of the first dielectric layers DEL1_R and the number of the second dielectric layers DEL2_R, and λ is the wavelength of the red light LR. Similarly, if the thickness of a layer having the maximum thickness among layers in the green color filter CF_G is indicated by Equation 2 above, N is the sum of the number of the third dielectric layers DEL1_G and the number of the fourth dielectric layers DEL2_G, and λ is the wavelength of the green light LG. Likewise, if the thickness of a layer having the maximum thickness among layers in the blue color filter CF_B is indicated by Equation 2 above, N is the sum of the number of the fifth dielectric layers DEL1_B and the number of the sixth dielectric layers DEL2_B, and λ is the wavelength of the blue light LB.

The display device 10 according to an embodiment of the present system and method may include the color filter CF that includes the first dielectric layer DEL1 and the second dielectric layer DEL2, and use the shutter panel SHP that maintains the polarity of the incoming light in its transmitted light to decrease light loss. Because light loss is decreased, it is possible to drive the display device 10 with low power consumption.

In the following, the present system and method are described with respect to particular embodiments but are not limited thereto.

### Embodiment 1

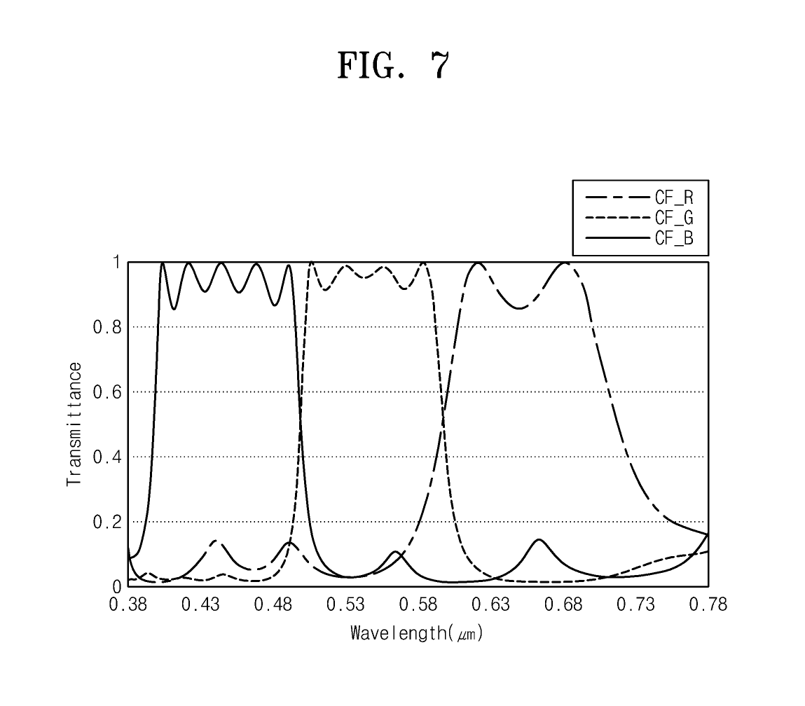

As used herein, “Embodiment 1” refers to an embodiment that implements the red color filter according to Table 1 above, the green color filter according to Table 2 above, and the blue color filter according to Table 3 above. FIG. 7 is a graph of wavelength vs. transmittance in the color filter of Embodiment 1. Specifically, FIG. 7 shows that the wavelengths of light being transmitted (i.e., wavelength ranges where transmittance ˜1) by each of the red color filter CF_R, green color filter CF_G, and blue color filter CF_B do not overlap, meaning, Embodiment 1 has high efficiency in the color gamut aspect.

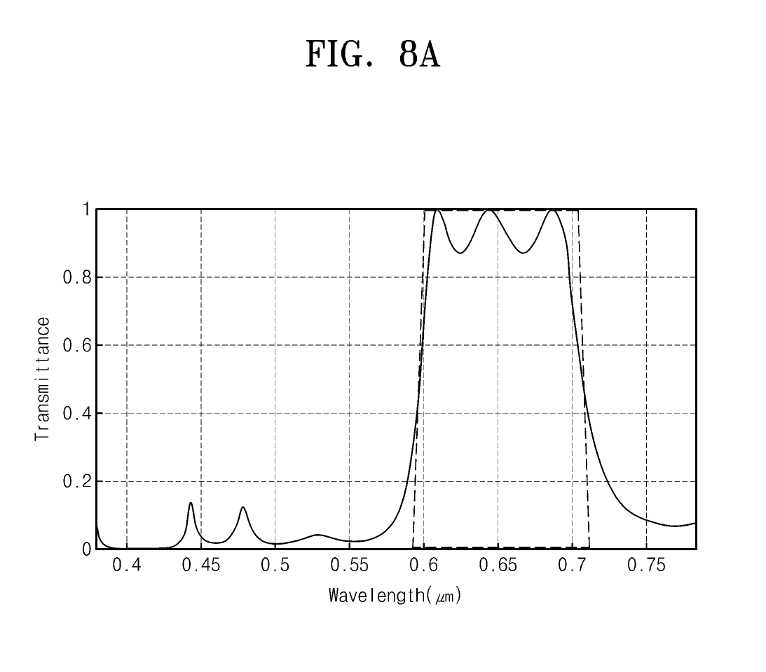

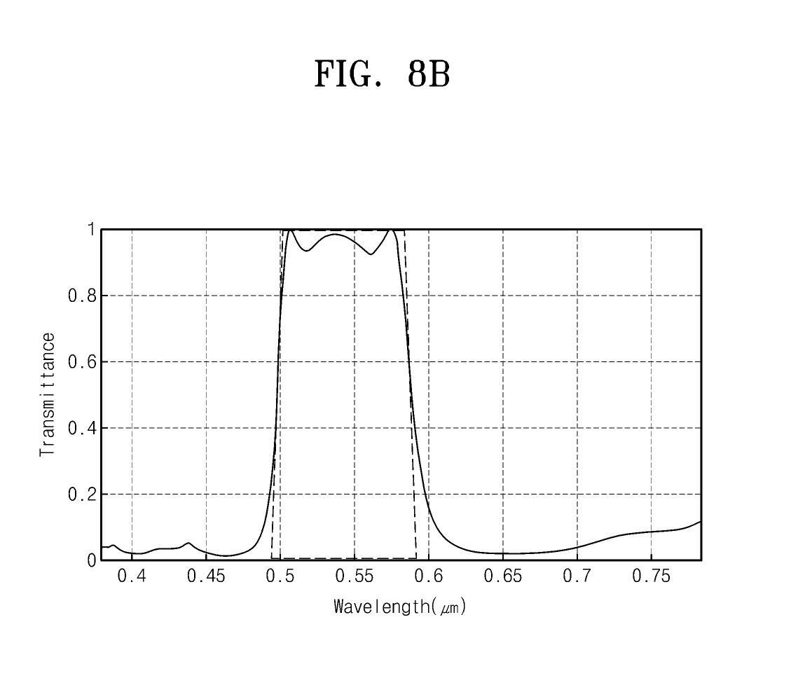

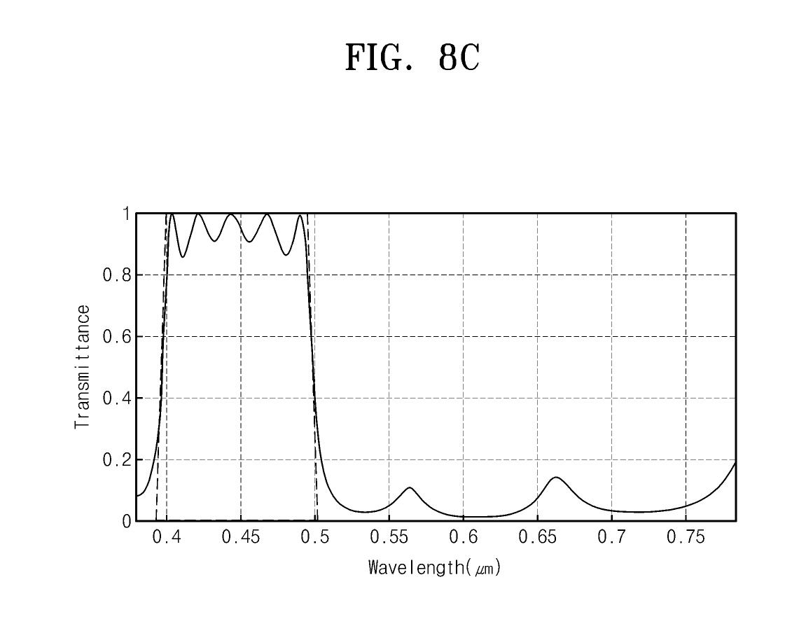

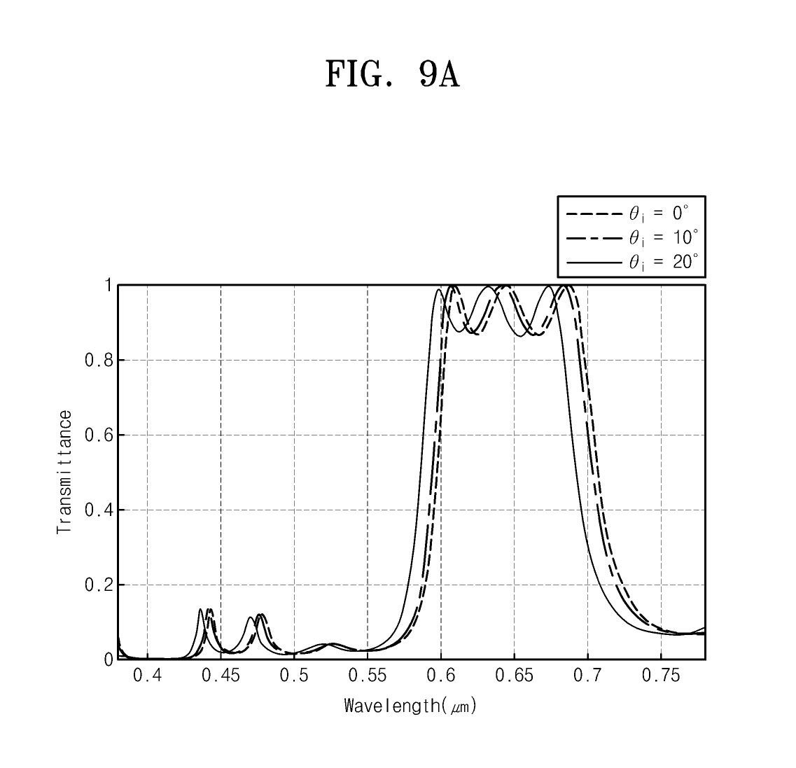

FIG. 8A is a graph of wavelength vs. transmittance in the red color filter of Embodiment 1. FIG. 8B is a graph of wavelength vs. transmittance in the green color filter of Embodiment 1. FIG. 8C is a graph of wavelength vs. transmittance in the blue color filter of Embodiment 1. Referring to FIGS. 7 and 8A, the red color filter has high transmittance on a wavelength region of about 600 nm to about 700 nm. Referring to FIGS. 7 and 8B, the green color filter has high transmittance on a wavelength region of about 500 nm to about 580 nm. Referring to FIGS. 7 and 8C, the blue color filter has high transmittance on a wavelength region of about 400 nm to about 490 nm.

### Embodiment 2

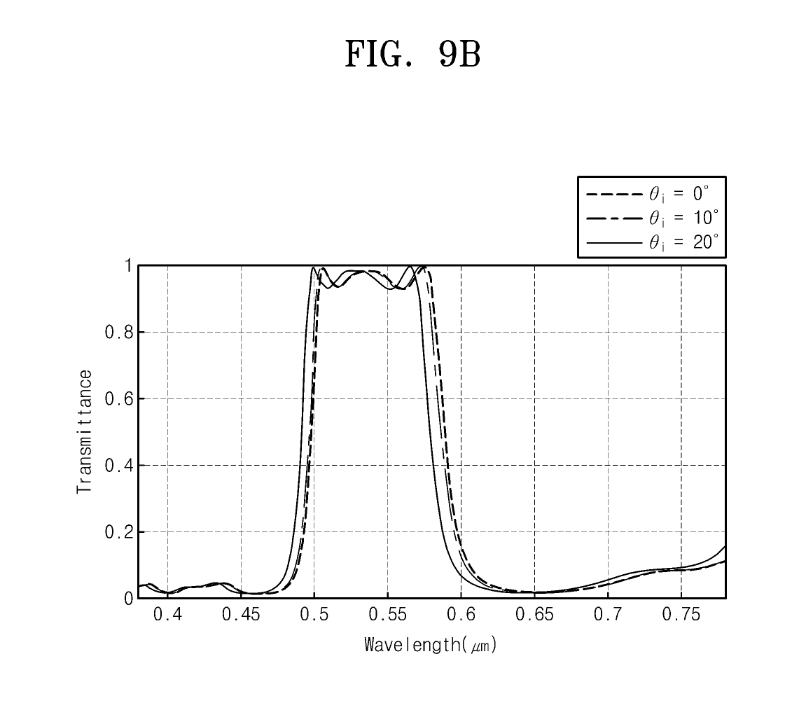

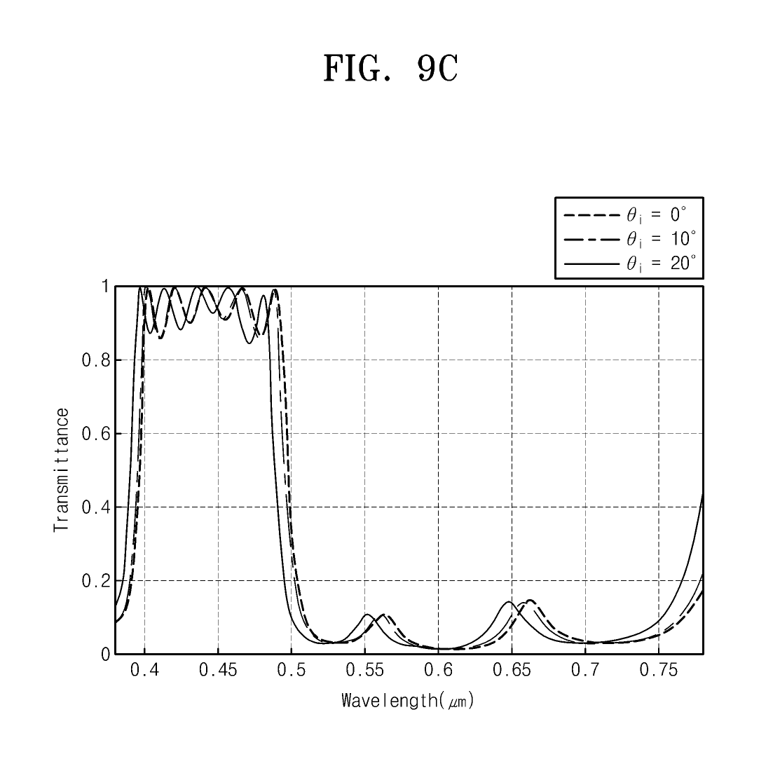

As used herein, “Embodiment 2” refers to an embodiment that implements the red color filter, the green color filter and the blue color filter of Embodiment 1 with white light having an emission angle of about 0°, about 10°/−10°, and about 20°/−20°. FIG. 9A is a graph of wavelength vs. transmittance in the red color filter of Embodiment 2. FIG. 9B is a graph of wavelength vs. transmittance in the green color filter of Embodiment 2. FIG. 9C is a graph of wavelength vs. transmittance in the blue color filter of Embodiment 2.

Referring to FIG. 9A, the red color filter has high transmittance on a wavelength region of about 600 nm to about 700 nm when its emission angle is about 0° and about 10°. When the emission angle is about 20°, the wavelength region having high transmittance is shifted to the left compared to the wavelength regions having high transmittance at emission angles of about 0° and about 10°. Referring to FIG. 9B, the green color filter has high transmittance on a wavelength region of about 500 nm to about 580 nm when its emission angle is about 0° and about 10°. When the emission angle is about 20°, the wavelength region having high transmittance is shifted to the left compared to the wavelength regions having high transmittance at emission angles of about 0° and about 10°. Referring to FIG. 9C, the blue color filter has high transmittance on a wavelength region of about 400 nm to about 490 nm when its emission angle is about 0° and about 10°. When the emission angle is about 20°, the wavelength region having high transmittance is shifted to the left compared to the wavelength regions having high transmittance at emission angles of about 0° and about 10°. Thus, the color filter according to Embodiment 2 has high transmittance over a range of emission angles.

According to the display device according to an embodiment of the present system and method, it is possible to provide a display device having high light efficiency.

While embodiments of the present system and method are described with reference to the accompanying drawings, a person skilled in the art would understand that the present system and method may be practiced in other forms without changing technical spirits or essential characteristics. Therefore, the above-described embodiments are illustrative and not limitative in any aspect.

What is claimed is:

1. A display device comprising:
a backlight unit providing light;
a color filter formed on the backlight unit and including a red color filter, a green color filter and a blue color filter; and
a shutter panel facing the color filter,
wherein the red color filter includes one or more first dielectric layers formed of at least a first material having a first refractive index and one or more second dielectric layers formed of at least a second material having a second refractive index smaller than the first refractive index, the first dielectric layers and the second dielectric layers being alternately stacked,
the green color filter includes one or more third dielectric layers formed of at least the first material and one or more fourth dielectric layers formed of at least the second material, the third dielectric layer and the fourth dielectric layer being alternately stacked,
the blue color filter includes one or more fifth dielectric layers formed of at least the first material and one or more sixth dielectric layers formed of at least the second material, the fifth dielectric layer and the sixth dielectric layer being alternately stacked, and
a sum of the number of the first dielectric layers and the number of the second dielectric layers is different from a sum of the number of the third dielectric layers and the number of the fourth dielectric layers.

2. The display device of claim 1, wherein the sum of the number of the first dielectric layers and the number of the second dielectric layers is the same as a sum of the number of the fifth dielectric layers and the number of the sixth dielectric layers.

3. The display device of claim 1, wherein the number of the first dielectric layers is different from the number of the second dielectric layers,
the number of the third dielectric layers is different from the number of the fourth dielectric layers, and
the number of the fifth dielectric layers is different from the number of the sixth dielectric layers.

4. The display device of claim 1, wherein a layer having the maximum thickness among layers in the red color filter is arranged between the outermost layers of the red color filter,
a layer having the maximum thickness among layers in the green color filter is arranged between the outermost layers of the green color filter, and
a layer having the maximum thickness among layers in the blue color filter is arranged between the outermost layers of the blue color filter.

5. The display device of claim 1, wherein the thickness of the green color filter is thicker than the thickness of the red color filter, and
the thickness of the blue color filter is thicker than the thickness of the green color filter.

6. The display device of claim 6, wherein the difference between the first refractive index and the second refractive index is about 0.5 to about 1.5.

7. The display device of claim 1, wherein the first material is TiO₂ and the second material is SiO₂.

8. The display device of claim 1, wherein the outermost layers of the red color filter are the first dielectric layers,
the outermost layers of the green color filter are the third dielectric layers, and
the outermost layers of the blue color filter are the fifth dielectric layers.

9. The display device of claim 1, wherein a layer having the maximum thickness among layers in the red color filter is the second dielectric layer,
a layer having the maximum thickness among layers in the green color filter is the fourth dielectric layer, and
a layer having the maximum thickness among layers in the blue color filter is the sixth dielectric layer.

10. The display device of claim 1, wherein the backlight unit provides a first light,
the color filter receives the first light, reflects at least a portion of the first light and emits a second light having a wavelength different from the reflected portion of the first light,
the shutter panel receives the second light from the color filter and transmits at least a portion of the second light, and
an oscillation direction of the second light received from the color filter and an oscillation direction of the portion of the second light transmitted by the shutter panel are the same.

11. The display apparatus of claim 10, wherein the red color filter emits red light,
the green color filter emits green light,
the blue color filter emits blue light, and
the thickness L of the red color filter, the green color filter or the blue color filter is determined by Equation 1 below:
$$∠ = {N}_{1} \frac{λ}{{n}_{1}} + {N}_{2} \frac{λ}{{n}_{2}} \qquad 〈 Equation 1 〉$$
where n1 is the first refractive index, n2 is the second refractive index, N1 is the number of the first dielectric layers, the number of the third dielectric layers, or the number of the fifth dielectric layers, N2 is the number of the second dielectric layers, the number of the fourth dielectric layers, or the number of the sixth dielectric layers, λ is the wavelength of red light, the wavelength of green light or the wavelength of blue light.

12. The display device of claim 10, wherein the thickness Lₘₐₓ of a layer having the maximum thickness among layers in the red color filter, the thickness Lₘₐₓ of a layer having the maximum thickness among layers in the green color filter, or the thickness Lₘₐₓ of a layer having the maximum thickness among layers in the blue color filter are determined by Equation 2 below:
$${∠}_{max} < \frac{λ N}{2} ( \frac{1}{{n}_{1}} + \frac{1}{{n}_{2}} ) \qquad 〈 Equation 2 〉$$
where n1 is the first refractive index, n2 is the second refractive index, N is the sum of the number of the first dielectric layers and the number of the second dielectric layers, the sum of the number of the third dielectric layers and the number of the fourth dielectric layers, or a sum of the number of the fifth dielectric layers and the number of the sixth dielectric layers, and λ is the wavelength of red light, the wavelength of green light or the wavelength of blue light.

13. The display device of claim 10, wherein an emission angle of the first light is −20° to +20°.

14. The display device of claim 10, wherein the shutter panel is at least one of a micro electro mechanical systems (MEMS) shutter panel, a liquid switch shutter panel, and a reflective polymer dispersed liquid crystal (PDLC) shutter panel.

15. The display device of claim 10, wherein the shutter panel comprises:
a shutter transmitting at least a portion of the second light received from the color filter; and
a switching element providing the shutter with an image signal voltage to change the light transmittance of the shutter.

16. The display device of claim 10, wherein the backlight unit comprises:
a light unit emitting the first light; and
a light guide plate guiding the first light received from the light unit to emit the first light.

17. The display device of claim 10, further comprising a diffusion sheet diffusing the second light passing through the shutter panel wherein the diffusion sheet is formed on the shutter panel.

18. The display device of claim 1, wherein each of the sum of the number of the first dielectric layers and the number of the second dielectric layers, the sum of the number of the third dielectric layers and the number of the fourth dielectric layers and a sum of the number of the fifth dielectric layers and the number of the sixth dielectric layers is an odd number.

19. The display device of claim 1, wherein the number of the first dielectric layers is ten,
the number of the second dielectric layers is nine,
the number of the third dielectric layers is thirteen,
the number of the fourth dielectric layers is twelve,
the number of the fifth dielectric layers is ten, and
the number of the sixth dielectric layers is nine.

20. The display device of claim 19, wherein the first and second dielectric layers in the red color filter are different from one another in thickness,
the first and fourth dielectric layers in the green color filter are different from one another in thickness, and
the first and sixth dielectric layers in the blue color filter are different from one another in thickness.
